(19) United States
(12) Patent Application Publication
(10) Pub. No.: US 2004/0084913 A1
(43) Pub. Date: May 6, 2004

(54) Hoist ring retainer

(76) Inventors: John P. Pelkey, South Windsor, CT (US); Lloyd B. Green JR., Dalton, MA (US)

Correspondence Address: PRATT & WHITNEY, 400 MAIN STREET, MAIL STOP: 132-13, EAST HARTFORD, CT, 06108, US

(21) Appl. No.: 10/641,739

(22) Filed: Aug. 15, 2003

Related U.S. Application Data
(60) Provisional application No. 60/319,477, filed on Aug. 16, 2002.

(51) Int. Cl. B66C 1/66

(52) U.S. Cl. 294/1.1

(57) ABSTRACT

A retainer for a hoist ring mounted on an apparatus, comprising: a body; a fastener extending through the body and mountable to the apparatus; and an element to control rotation of the body. The element to control rotation of the body could be a friction member between the body and the fastener such as a spring.

### CROSS-REFERENCE TO RELATED APPLICATIONS

This Application claims the benefit of U.S. Provisional Patent Application No. 60/319,477, filed on Aug. 16, 2002, herein incorporated by reference.

### BACKGROUND OF THE INVENTION

This invention relates to hoist rings. Specifically, this invention relates to a retainer for securing a hoist ring in a stowed position.

The placement of hoist rings on fixtures helps the transportation or handling of the fixtures. After such transportation or handling, however, the need for the hoist ring no longer exists. In fact, securing the hoist ring after such transportation or handling helps prevent damage to the fixture or nearby components during subsequent operations using the fixture.

### BRIEF SUMMARY OF THE INVENTION

One embodiment of the present invention is a retainer for a hoist ring mounted on an apparatus, comprising: a body; a fastener extending through the body and mountable to the apparatus; and a means for controlling rotation of the body.

Another embodiment of the present invention is a retainer for a hoist ring mounted on an apparatus, comprising: a body; a fastener extending through the body and mountable to the apparatus; and a friction member between the body and the fastener to control rotation of the body.

Another embodiment of the present invention is a hoist ring assembly, comprising: a hoist ring mountable to an apparatus and movable between a deployed position and a stowed position; and a retainer adjacent the hoist ring for keeping the hoist ring in the stowed position. The retainer comprises: a body; a fastener extending through the body and mountable to the apparatus; and a friction member between the body and the fastener. The spring controls rotation of the body.

### BRIEF DESCRIPTION OF THE DRAWINGS

Other uses and advantages of the present invention will become apparent to those skilled in the art upon reference to the specification and the drawings, in which:

FIG. 1 is a perspective view of one type of conventional hoist ring assembly;

FIGS. 2a and 2b are perspective views of another type of conventional hoist ring assembly in a fully stowed and a partially stowed position, respectively;

FIGS. 3a and 3b are perspective views of one embodiment a hoist ring assembly of the present invention in a fully stowed and a partially stowed position, respectively; and

FIG. 4 is a cross-sectional view of the hoist ring retainer of FIG. 3a taken along line IV-IV.

### DETAILED DESCRIPTION OF THE INVENTION

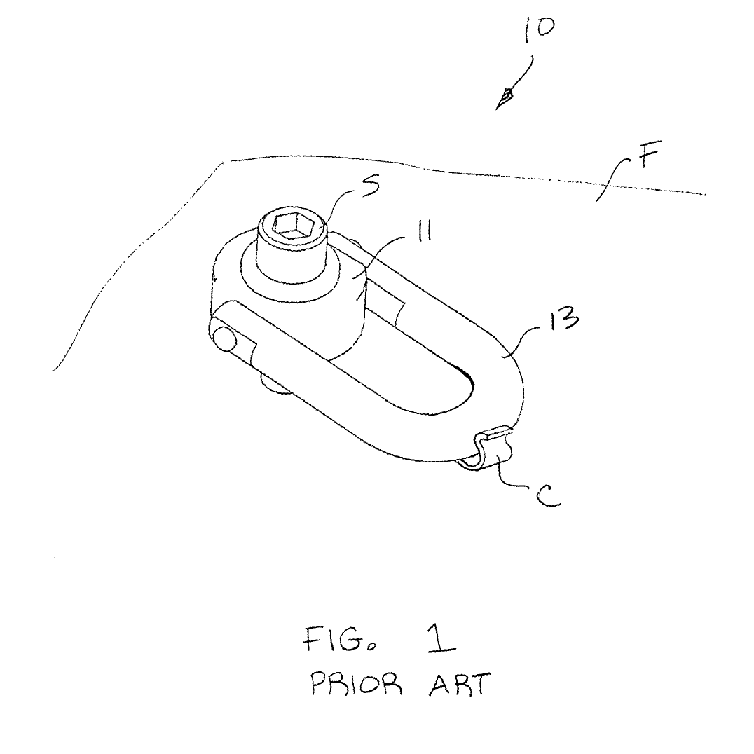

FIG. 1 displays a conventional hoist ring assembly 10. The assembly 10 includes a base 11 that rotatably secures to a fixture F with a screw S or other suitable fastener. A hoist ring 13 pivotally mounts to the base 11 in a conventional manner. The ring 13 can pivot between a stowed position (adjacent the fixture F) and a deployed position (extending transversely from the fixture F)

To transport or handle the fixture F, an operator pivots the ring 13 from the stowed position to the deployed position. This allows the operator to engage the ring 13 with a suitable lifting device such as a hoist (not shown).

After transportation or handling, the operator stows the assembly 10 by returning the ring 13 to the stowed position and securing the ring 13 to the fixture F with a retainer. Specifically, the assembly uses a clip C mounted to the fixture F as the retainer. The clip C is typically a spring clip. These clips C, however, tend to break even under normal wear and tear. The broken clips C can produce sharp edges at the break. Most importantly, the broken clips C no longer serve to secure the ring 13 at the stowed position. Also, the ability of these clips C to retain the rings 13 decreases with time as the memory of the spring deteriorates.

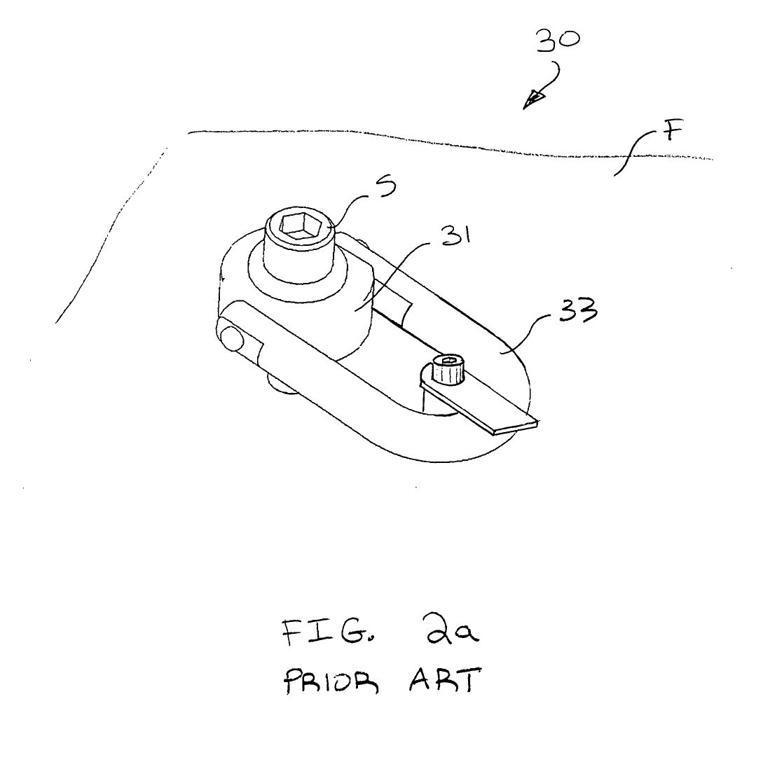

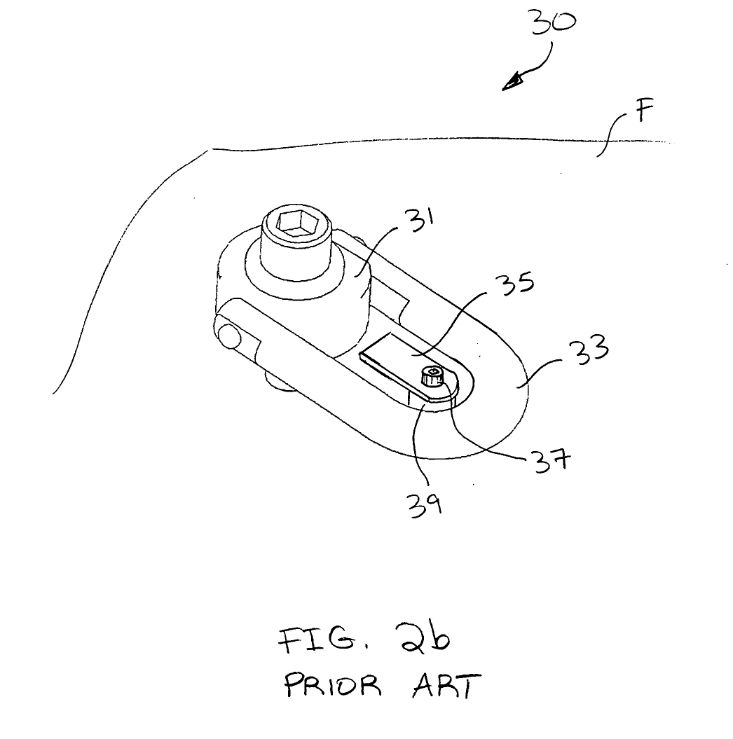

FIGS. 2a and 2b display another conventional hoist ring assembly 30. Similar to the aforementioned assembly 10, the assembly 30 includes a base 31 rotatably secured to a fixture F with a screw S or other suitable fastener. A hoist ring 33 pivotally mounts to the base 31 in a conventional manner.

The assembly 30 also uses a retainer to secure the ring 33 to the fixture F. Specifically, the assembly 30 uses a rotatable arm 35. A screw 37 retains the arm 35 against a bushing 39 mounted to the fixture F.

FIG. 2a displays the assembly 30 in a fully stowed configuration. To deploy the ring 33 for transporting or handling the fixture F, an operator must loosen the screw 37, rotate the arm 35 to an inoperative position (i.e. within the perimeter of the ring 33), then tighten the screw 37 (so the arm 35 remains within the perimeter of the ring 33 and does not interfere with deployment of the ring 33). FIG. 2b shows the assembly 30 in a partially stowed position. From this partially stowed position, the operator can now pivot the ring 33 to the deployed position without interference from the retainer.

After transporting or handling the fixture F, the operator must reverse the process. Namely, the operator must return the ring to the stowed position, loosen the screw 37, rotate the arm 35 to an operative position over the ring 33, then tighten the screw 37 (so the arm 35 remains over the ring 33). The assembly 30 is now in the arrangement show in FIG. 2a. This process involves multiple steps and requires the operator to carry a hand tool, such as a hex wrench, to tighten and to loosen the screw 37.

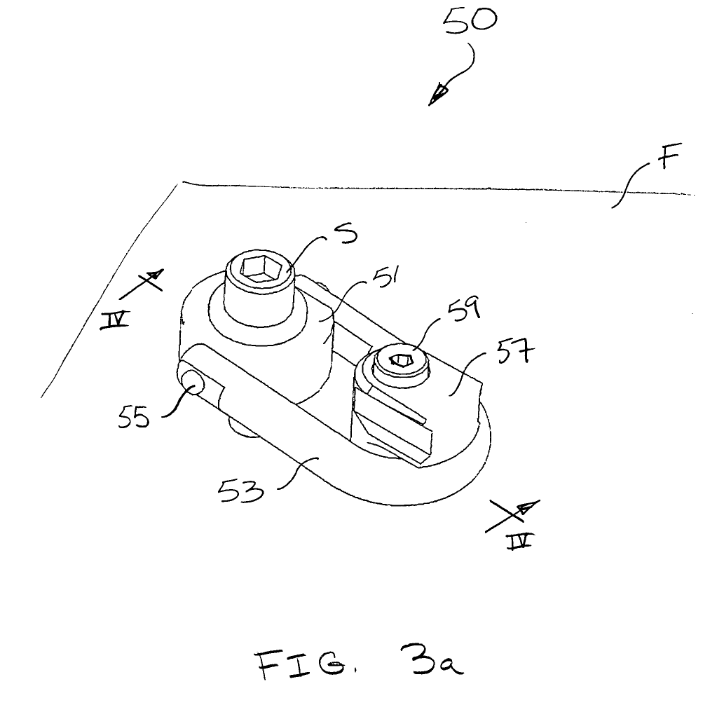

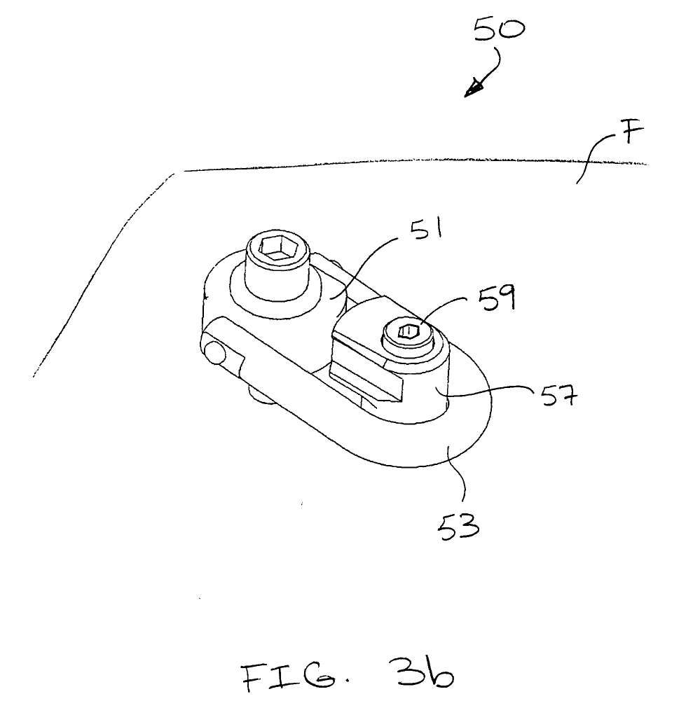

FIGS. 3a and 3b display one embodiment of a hoist ring assembly 50 of the present invention. The assembly 50 includes a base 51 rotatably secured to a fixture F with a suitable fastener, such as a screw S. A hoist ring 53 pivotally mounts to the base 31 in any known manner, such as with a pin 55.

The assembly 50 also uses a retainer to secure the ring 53 to the fixture F. Specifically, the assembly 50 uses a rotatable arm 57. A shoulder screw 59 helps mount the arm 57 to the fixture F. The shoulder screw 59 bottoms out within a corresponding threaded blind hole in the fixture F. This creates a space between the shoulder screw 59 and the arm 57. Differently than the aforementioned assembly 30, the assembly uses an element that biases the arm 57 relative to the screw 59. The assembly uses a spring 61 to span the space between the arm 57 and the shoulder screw 59. The spring 61 could be a coil spring.

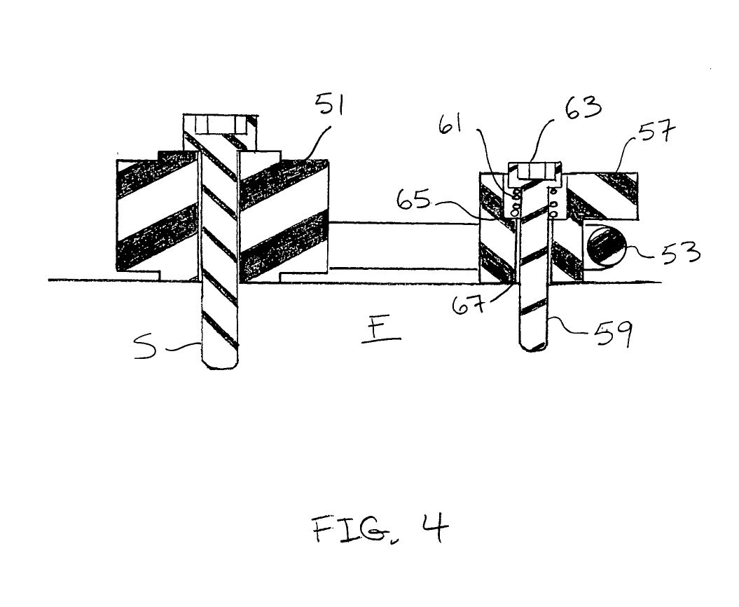

As specifically seen in FIG. 4, the spring 61 locates between a head 63 of the screw 59 and a shoulder 65 within an opening 67 in the arm through which the screw 59 extends. The spring 61 biases the arm 57 away from a head 63 of the screw 59 and against the fixture F. The bias force created by the spring 61 is sufficient to control rotation of the arm 57. In other words, the spring 61 frictionally retains the arm 57 against the fixture F to retain the arm 57 at any position during normal operation of the fixture F. If the assembly 50 requires additional biasing force to ensure the arm 57 does not rotate during operation of the fixture F, the operator could replace the spring 61 with a spring having a higher rated load (measured in pounds of force) by removing the screw 61.

FIG. 3a displays the assembly 50 in a fully stowed configuration. To deploy the ring 53 for transporting or handling the fixture F, the operator merely rotates the arm 57 to a position within the perimeter of the ring 53. The operator can rotate the arm 57 without loosening the screw 59. The operator applies a force to the arm 57 sufficient to overcome the biasing force of the spring 61. FIG. 3b shows the assembly 50 in a partially stowed position. In this partially stowed position, the operator can now pivot the ring 53 to the deployed position for engaging the hoist.

After transporting or handling the fixture F, the operator reverses the process. Namely, the operator places the ring 53 against the fixture, then rotates the arm 57 to a position over the ring 53.

The present invention has been described in connection with the preferred embodiments of the various figures. It is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

1. A retainer for a hoist ring mounted on an apparatus, comprising:
a body;
a fastener extending through said body and mountable to said apparatus; and
a means for controlling rotation of said body.

2. The retainer of claim 1, wherein said means for controlling comprises a spring.

3. The retainer of claim 2, wherein said spring comprises a compression spring.

4. The retainer of claim 1, wherein said means for controlling allows rotation of said body without loosening said fastener.

5. A retainer for a hoist ring mounted on an apparatus, comprising:
a body;
a fastener extending through said body and mountable to said apparatus; and
a friction member between said body and said fastener to control rotation of said body.

6. The retainer of claim 5, wherein said friction member is a spring.

7. The retainer of claim 6, wherein said fastener includes a head and said body includes a shoulder, said spring located between said head and said shoulder.

8. The retainer of claim 6, wherein said spring comprises a compression spring.

9. The retainer of claim 6, wherein said spring surrounds said fastener.

10. A hoist ring assembly, comprising:
a hoist ring mountable to an apparatus and movable between a deployed position and a stowed position; and
a retainer adjacent said hoist ring for keeping said hoist ring in said stowed position, said retainer comprising:
a body;
a fastener extending through said body and mountable to said apparatus; and
a friction member between said body and said fastener;
wherein said spring controls rotation of said body.

11. The hoist ring assembly of claim 10, wherein said friction member is a spring.

12. The assembly of claim 11, wherein said fastener includes a head and said body includes a shoulder, said spring located between said head and said shoulder.

13. The assembly of claim 11, wherein said spring comprises a compression spring.

14. The assembly of claim 11, wherein said spring surrounds said fastener.
